(19) United States
(12) Patent Application Publication
(10) Pub. No.: US 2026/0113194 A1
(43) Pub. Date: Apr. 23, 2026

(54) Secure Access to Applications by Support User Accounts

(71) Applicant: Dell Products L.P., Round Rock, TX (US)

(72) Inventors: Ananthakrishnan Balakrishnan, Edison, NJ (US); Danil Safronov, Warszawa (PL); Seema M. Tahaliyani, Southborough, MA (US); Yuanyuan Zhang, Newark, CA (US); Chetan Kulkarni, Pune, Maharashtra (IN); Paolo Villanueva, Beaverton, OR (US)

(21) Appl. No.: 18/924,918

(22) Filed: Oct. 23, 2024

(51) Int. Cl. H04L 9/32; H04L 9/08

(52) U.S. Cl. CPC H04L 9/3228; H04L 9/085; H04L 9/0861; H04L 9/3268

(57) ABSTRACT

A system can generate a vendor secret key for a customer site, and a vendor public key for based on the vendor secret key and a first number that comprises a primitive root modulo of a second prime number. The system can embed the vendor public key and an identifier of an application in a signed certificate. The system can enable access to the certificate and the first number a customer entity that is associated with the customer site, the customer entity validating the certificate via the customer device, wherein the validating comprises validating that the certificate was generated by the system, and wherein the validating comprises validating that the identifier of the application of the customer site in the certificate matches a locally-stored copy of the identifier of the application of the customer site. The system can, based on the validating, access the application of the customer site.

### BACKGROUND

User accounts can be authenticated before being permitted to access particular computer services.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can generate a vendor secret key for a customer site. The system can generate a vendor public key for the customer site based on the vendor secret key and a first number that comprises a primitive root modulo of a second prime number. The system can embed the vendor public key and an identifier of an application of the customer site in a certificate, wherein the certificate is signed. The system can enable access to the certificate and the first number via a customer device corresponding to a customer entity that is associated with the customer site, the customer entity validating the certificate via the customer device, wherein the validating comprises validating that the certificate was generated by the system, and wherein the validating comprises validating that the identifier of the application of the customer site in the certificate matches a locally-stored copy of the identifier of the application of the customer site. The system can, based on the validating, access the application of the customer site.

An example method can comprise generating, by a system comprising at least one processor, a vendor public key for a customer site based on a vendor secret key for the customer site and a first number that comprises a primitive root modulo of a second prime number. The method can further comprise embedding, by the system, the vendor public key and an identifier of an application of the customer site in a certificate, wherein the certificate is signed. The method can further comprise enabling, by the system, access to the certificate and the first number via customer equipment of a customer entity that is associated with the customer site, the customer entity validating the certificate via the customer equipment, wherein the validating comprises validating that the certificate was generated by the system, and wherein the validating comprises validating that the identifier of the application of the customer site in the certificate matches a locally-stored copy of the identifier of the application of the customer site. The method can further comprise, based on the validating, accessing, by the system, the application of the customer site.

An example non-transitory computer-readable medium can comprise instructions that, in response to execution, cause a system comprising a processor to perform operations. These operations can comprise generating a public key for site equipment associated with a site based on a secret key for the site and a first number that comprises a primitive root modulo of a second prime number. These operations can further comprise embedding the public key and an identifier of an application of the site equipment in a certificate. These operations can further comprise enabling access to the certificate and the first number by an entity that is associated with the site equipment, the entity validating the certificate, wherein the validating comprises validating that the certificate was generated by the system, and wherein the validating comprises validating that the identifier of the application of the site equipment in the certificate matches a locally-stored copy of the identifier of the application of the site equipment. These operations can further comprise based on the validating, accessing the application of the site equipment.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate secure access to applications by support user accounts, in accordance with an embodiment of this disclosure;

FIG. 2 illustrates an example workflow of a customer site setup, and that can facilitate secure access to applications by support user accounts, in accordance with an embodiment of this disclosure;

FIG. 3 illustrates an example workflow of a support user login, and that can facilitate secure access to applications by support user accounts, in accordance with an embodiment of this disclosure;

FIG. 4 illustrates an example process flow that can facilitate secure access to applications by support user accounts, in accordance with an embodiment of this disclosure;

FIG. 5 illustrates another example process flow that can facilitate secure access to applications by support user accounts, in accordance with an embodiment of this disclosure;

FIG. 6 illustrates another example process flow that can facilitate secure access to applications by support user accounts, in accordance with an embodiment of this disclosure;

FIG. 7 illustrates another example process flow that can facilitate secure access to applications by support user accounts, in accordance with an embodiment of this disclosure;

FIG. 8 illustrates another example process flow that can facilitate secure access to applications by support user accounts, in accordance with an embodiment of this disclosure;

FIG. 9 illustrates another example process flow that can facilitate secure access to applications by support user accounts, in accordance with an embodiment of this disclosure;

FIG. 10 illustrates another example process flow that can facilitate secure access to applications by support user accounts, in accordance with an embodiment of this disclosure; and

FIG. 11 illustrates an example block diagram of a computer operable to execute an embodiment of this disclosure.

### DETAILED DESCRIPTION

### Overview

There can be situations where a vendor support user will troubleshoot a customer application within the customer's data center. In order to do that, it can be that the vendor support user has a valid set of credentials usable to login to the application at the customer site. These applications can be positioned behind a customer firewall and not be connected to the internet. In such scenarios, it can be that the support user either has to physically visit the data center, or customers have to provide remote access to the application where they can furnish the appropriate vendor trusted identity/credentials to login to the customer application. This situation can be further complicated where there can be no direct secure channel between the customer application and vendor identity provider. The present techniques can address these problems by providing an approach for secure access despite the lack of a secure channel. This can be effectuated using a challenge-response mechanism for a vendor support user to obtain temporary credentials that can be used to identify, authenticate, and authorize the user to the customer application. The present techniques can also provide for tying into an existing audit logging facility so that actions by the support user can be audit logged.

According to the present techniques, a vendor can generate a customer site specific public key wrapped in a certificate, while keeping the corresponding private key safely in its key management servers (KMS). This certificate can be uploaded to the customer site application after deployment and before going into production. When a vendor support user requests access, the vendor support user can attempt to log in to the application, at which time a quick-response (QR) code with a challenge payload can be generated (in some examples, the challenge payload can be delivered in other ways, such as email). The support user can use an app on their phone to connect securely to the vendor support user site and upload the challenge payload, and gets back a dynamically generated password and a time-based one time password (TOTP) authenticator valid for a configurable fixed period of time. The support user can establish a session with the customer application with the password and TOTP to troubleshoot the system. In some examples, the receiving of the challenge payload can be performed via an insecure channel, and the present techniques can be implemented such that this does not affect overall security of the approach.

Prior approaches can have problems. A prior approach can involve customer-provisioned identity and credentials for vendor support users with support role privileges. Since admins from the customer side can provision users with support role(s), there can be scope for misuse. Vendor support users can have to adhere to a customer security policy and periodically change passwords before they expire. This can be untenable when it can be performed across multiple customers. When a vendor support user leaves the vendor organization, it can be difficult to reconcile the scenario and delete the user.

Another prior approach can involve vendor generated credentials based on a signature using a private key stored at the vendor site, and that can be verified by a customer application using a public key. Each credential can be unique per customer. Typically, these do not tie to a vendor support user identity, so auditability can be difficult. It can be that there can be only a single set of credentials without the use of TOTP to gate privileged operations. Typically, this approach lacks a challenge-response mechanism.

There can be prior approaches that install a vendor support gateway at a customer site. A problem can be that customers want to be able to trust the vendor to deploy the gateway properly, and this trust level can be higher than otherwise due to computer components being installed at the customer site.

Trust can be established once, during a gateway deployment, and a customer is not involved in each access request. The gateway can request access to the vendor site, and there can be a corresponding request to create a hole through a customer firewall. It can be that gateway access requests to be protected, and that the gateway requests to be scanned for vulnerabilities (and that it adds an extra surface for attack).

The present techniques can incorporate a challenge-response mechanism where the challenge payload passes through an insecure channel and still provides secure access to a customer application by vendor support users. This challenge-response mechanism can be one where the customer initiates the challenge phase workflow. This mechanism can provide a clear identity for a vendor support user, which can be useful for audit-logging purposes.

The challenge-response mechanism can provide time-limited (as set by the customer) secure credentials for access to a customer application. In some examples, the credentials can be revoked before the defined time limit, and revoked by the customer.

The challenge-response mechanism can provide for both a password and a TOTP mechanism. The TOTP aspect can allow for added security to perform privileged operations.

The present techniques can prevent a single bad actor customer administrator from escalating privileges using a support role.

According to the present techniques, the application and customer support portal can independently compute the shared secret using the challenge. This shared secret can then be used to derive hash-based message authentication codes (HMAC) and TOTP keys for further use. A shared secret can be distinguished from a private key or a public key. It can be a secret that is shared between multiple entities (e.g., a vendor computer and a customer computer).

The application side shared secret can be calculated from vpk as follows shared_c=vpk^{ssk}=(g^{vsk})^{ssk}. The application side can determine the challenge as, challenge=g^{ssk}. Given g^{ssk}, it can be that it is difficult to determine the original values g and ssk. This can be considered a form of a discrete log problem. Additionally, it can be that (g^{vsk})^{ssk}=(g^{ssk})^{vsk}.

It can be that exponentiation operations can be modular exponentiation, and knowing the value for the challenge, it can be difficult to obtain the corresponding secret ssk. At the customer support portal, the shared secret can be calculated as shared_v=challenge^{vsk}=(g^{ssk})^{vsk}.

This can imply that shared_c=vpk^{ssk}=(g^{vsk})^{ssk}=g^{vsk.ssk}=g^{ssk.vsk}=(g^{ssk})^{vsk}=challenge^{vsk}=shared_v.

Once a shared secret is possessed on both sides, a key derivation can be performed to obtain HMAC and TOTP keys to obtain a password and TOTP tokens.

A setup workflow according to the present techniques can be implemented as follows. A vendor can set up a customer support portal for specifying appropriate cryptographic parameters, generating and managing keys for customer sites.

Keys managed by the customer support portal can be securely generated, stored and managed on an external KMS at the vendor site.

A vendor can decide on a multiplicative group of integers modulo a prime p, where g can be a primitive root modulo p. This can be performed on a customer deployment/site basis.

The vendor can generate a vendor secret key (vsk) for a site, and use it to determine the corresponding vendor public key (vpk=g^{vsk}).

The vsk can be stored securely in the external KMS.

The vpk can be embedded in a certificate (vcert) signed by the vendor. This site/application id (app_id) can be also embedded into the certificate.

The vsk, app_id, and (vcert, g) can be stored securely in the external KMS. The vendor can distribute the certificate vcert along with the cryptographic parameter g to the customer. The customer can log into the application and upload the certificate vcert and g.

The application can verify the validity of the certificate by ensuring that it was generated by the vendor. It can then verify that the site/application id embedded in the certificate matches its own.

It can then store these two in its secure store (which, in different examples, can be internal or external).

A support user login workflow can be implemented as follows. A customer can initiate a support user login session with the application over a secure channel. In some examples, the support user can implement this workflow.

The application can retrieve (vcert, g) from the secrets store and perform the following steps to generate the challenge payload:
Generate a random session id (sess_id).
Generate a session secret key (ssk).
Generate a challenge=g^{ssk}.
Determine a shared secret as, shared_c=vpk^{ssk} (in some examples, this can be the same as g^{vsk.ssk}).
Use a key derivation function to generate a hmac_key and totp_key:
(hmac_key, totp_key)=PBKDF2(HMAC, shared_c, sess_id, iterations, key-length), where PBKDF2 is a password-based key derivation function 2.
Store (sess_id, hmac_key, totp_key) securely in a secrets store.
Create a challenge payload (ch_payload) comprising the following and store it in the application:
   Session id—sess_id.
   Site/application id—app_id.
   The generated challenge.
Generate a QR code containing the challenge payload (qr_challenge).

A customer can then send the raw challenge payload (ch_payload) or QR code (qr_challenge) to the support user over insecure channel (e.g., email). The support user can then log in to the phone application using the vendors corporate credentials.

The support user can then upload the QR code or challenge payload to the application, which can communicate securely with a customer support portal.

The customer support portal can perform the following to generate a password and TOTP authenticator:
Retrieve the email_id of the support user.
Use the app_id to retrieve the corresponding vsk for the site/application id.
Determine a shared secret as follows: shared_v=challenge^{vsk} (in some examples, this can be the same as shared_c=g^{ssk.vsk})/
Use a key derivation function to generate a hmac_key and totp_key: (hmac_key, totp_key)=PBKDF2(HMAC, shared_v, sess_id, iterations, key-length).
Generate a password as follows: password=HMAC(hmac_key, sess_id+email_id).
Return the (password, totp_key, sess_id) to the support user phone application.

The support user can now have items to login to the application. The support user can generate a current TOTP token (totp_cur). The support user can also instantiate a login to the application using sess_id: email_id for a username and password:totp_cur for credentials.
The application can perform the following to verify the credentials:
Extract the sess_id and email_id from username.
Extract the password and totp_cur from credentials.
Use the sess_id to retrieve the corresponding (hmac_key, totp_key).
Compute the password to verify as password_v=HMAC(hmac_key, sess_id+email_id).
Compute the TOTP token to verify totp_cur_v.
   Verify that password_v matches password provided and totp_cur_v matches totp_cur.
If verification is successful, then create a support user session. Otherwise, error out.

### Example Architectures, ETC.

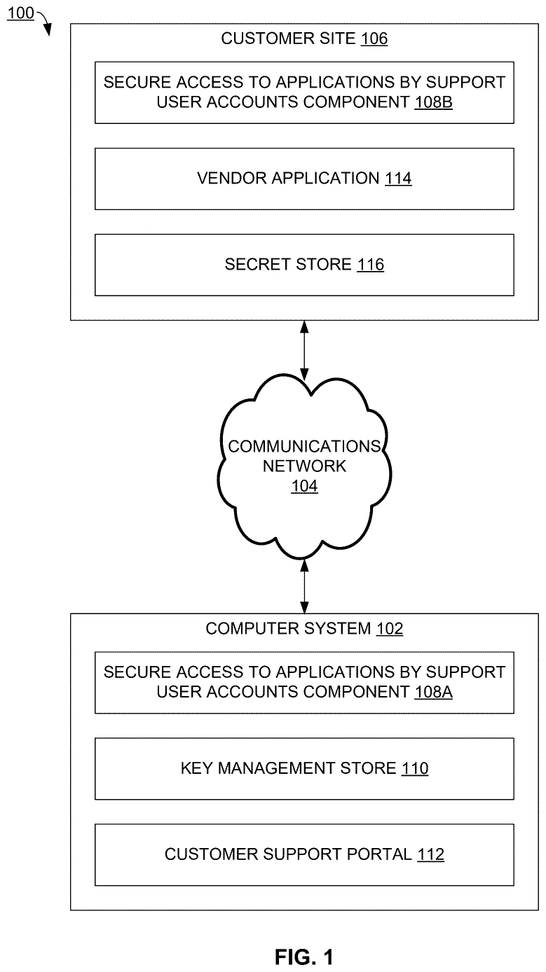

FIG. 1 illustrates an example system architecture 100 that can facilitate secure access to applications by support user accounts, in accordance with an embodiment of this disclosure.

System architecture 100 comprises vendor site 102 (which can comprise a computer system), communications network 104, and customer site 106 (which can comprise a computer system). In turn, vendor site 102 comprises secure access to applications by support user accounts component 108A, key management store 110, and customer support portal 112. And customer site 106 comprises secure access to applications by support user accounts component 108B, vendor application 114, and secret store 116.

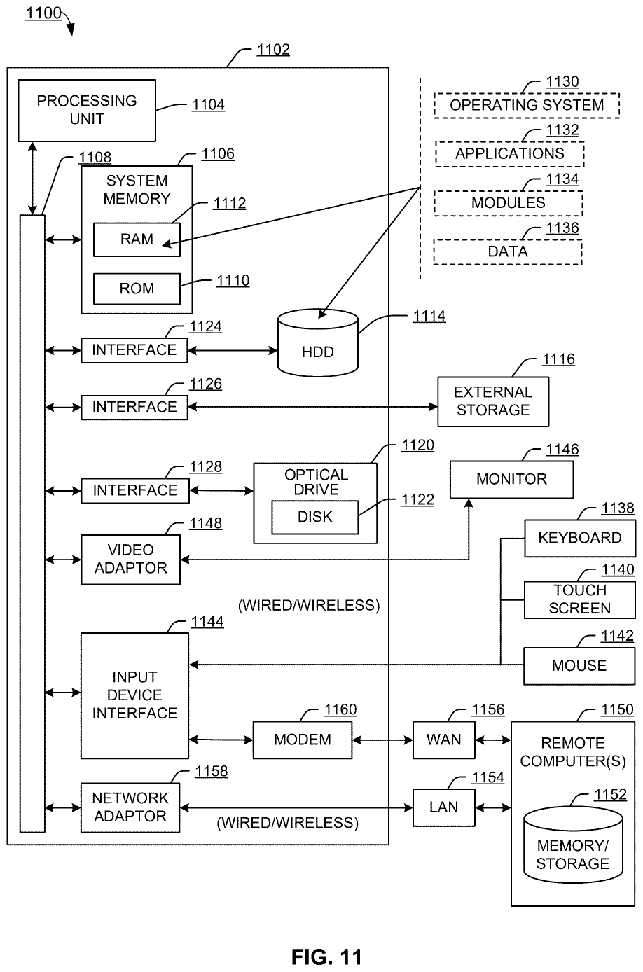

Each of vendor site 102 and/or customer site 106 can be implemented with part(s) of computing environment 1100 of FIG. 11. Communications network 104 can comprise a computer communications network, such as the Internet, or an isolated private computer communications network.

Vendor site 102 can communicate with customer site 106 via communications network 104, to both establish a mechanism by which a user account at vendor site 102 can access vendor application 114 at customer site 106 (e.g., to troubleshoot it), and by which a login according to that mechanism can occur. This can be facilitated on the vendor site 102 side by secure access to applications by support user accounts component 108A, which can leverage key management store 110, and customer support portal 112. This can be facilitated on the customer site 106 side by secure access to applications by support user accounts component 108B, which can leverage vendor application 114, and secret store 116.

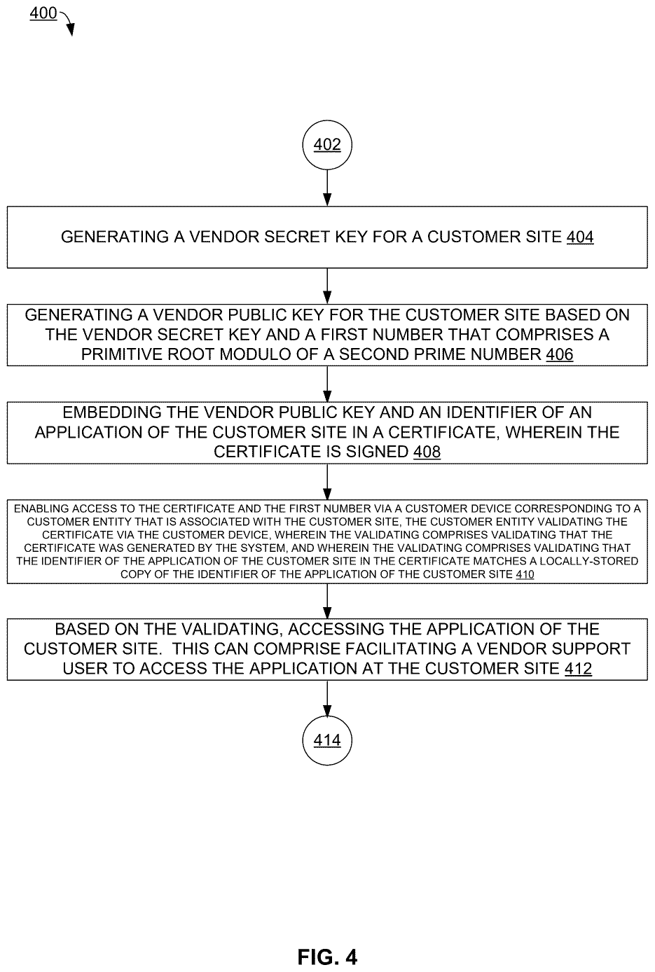

In some examples, secure access to applications by support user accounts component 118 can implement part(s) of the process flows of FIGS. 4-10 to facilitate secure access to applications by support user accounts.

It can be appreciated that system architecture 100 is one example system architecture for secure access to applications by support user accounts, and that there can be other system architectures that facilitate secure access to applications by support user accounts.

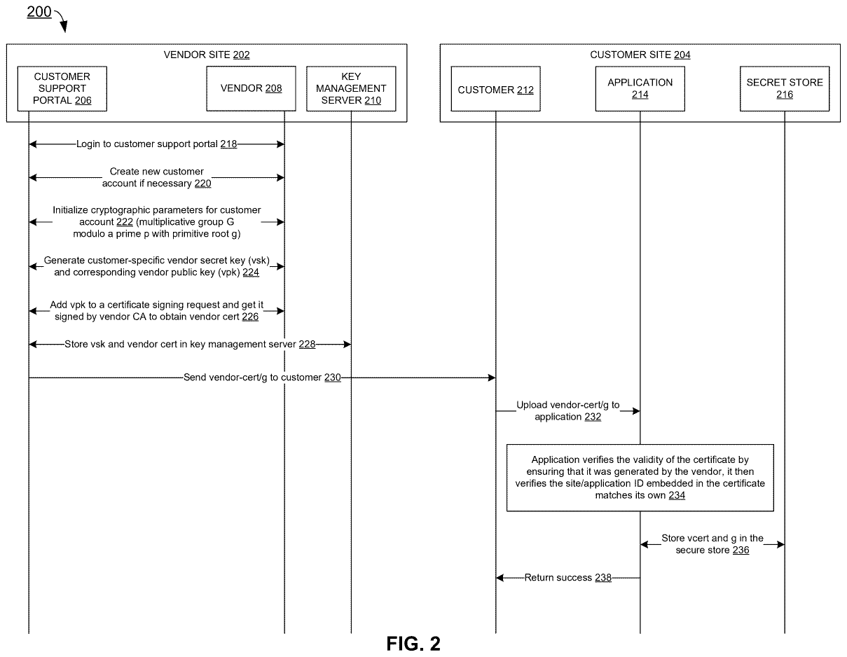

FIG. 2 illustrates an example workflow 200 of a customer site setup, and that can facilitate secure access to applications by support user accounts, in accordance with an embodiment of this disclosure. In some examples, part(s) of workflow 200 can be implemented by part(s) of system architecture 100 of FIG. 1 to facilitate secure access to applications by support user accounts.

The flows of workflow 200 occur between customer support portal 206, vendor 208, key management server 210, customer 212, application 214, and secret store 216. Vendor site 202 comprises customer support portal 206, vendor 208, and key management server 210; and customer site 204 comprises customer 212, application 214, and secret store 216.

The flows of workflow 200 are:
Login to customer support portal 218;
Create new customer account if not yet created 220;
Initialize cryptographic parameters for customer account 222 (multiplicative group G modulo a prime p with primitive root g);
Generate customer-specific vendor secret key (vsk) and corresponding vendor public key (vpk) 224;
Add vpk to a certificate signing request and get it signed by vendor CA to obtain vendor cert 226;
Store vsk and vendor cert in key management server 228;
Send vendor-cert/g to customer 230;
Upload vendor-cert/g to application 232;
Application verifies the validity of the certificate by ensuring that it was generated by the vendor, it then verifies the site/application ID embedded in the certificate matches its own 234;

### Store Vcert and G in the Secure Store 236; and

Return success 238.

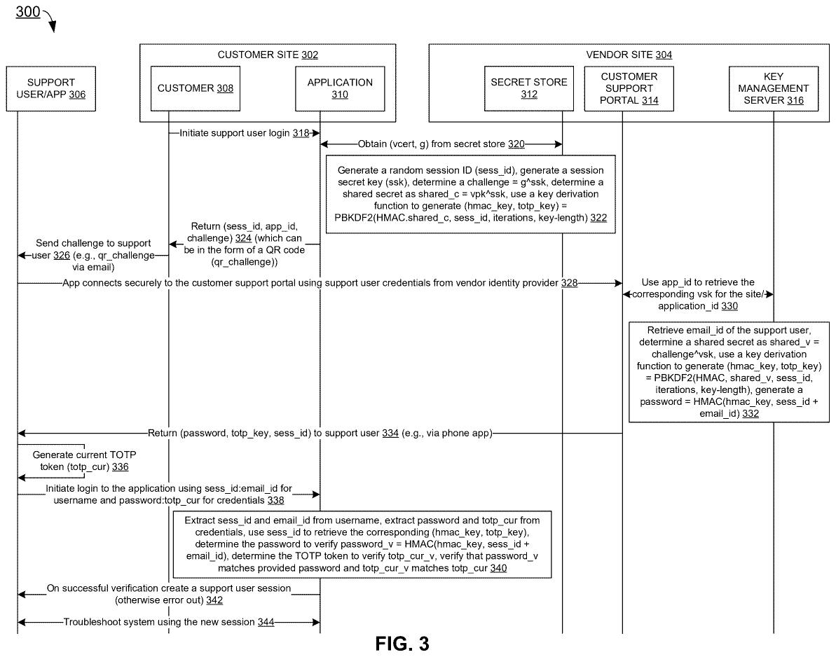

FIG. 3 illustrates an example workflow 300 of a support user login, and that can facilitate secure access to applications by support user accounts, in accordance with an embodiment of this disclosure. In some examples, part(s) of workflow 300 can be implemented by part(s) of system architecture 100 of FIG. 1 to facilitate secure access to applications by support user accounts.

The flows of workflow 300 occur between support user/app 306, customer 308, application 310, secret store 312, customer support portal 314, and key management server 316.

Customer site 302 comprises customer 308, application 310, and secret store 312; and vendor site 304 comprises customer support portal 314, and key management server 316.

The flows of workflow 300 are:
Initiate support user login 318;
Obtain (vcert, g) from secret store 320;
Generate a random session ID (sess_id), generate a session secret key (ssk), determine a challenge=g\hat{ }ssk, determine a shared secret as shared_c=vpk\hat{ }ssk, use a key derivation function to generate (hmac_key, totp_key)=PBKDF2(HMAC.shared_c, sess_id, iterations, key-length) 322;
Return (sess_id, app_id, challenge) 324 (which can be in the form of a QR code (qr_challenge));
Send challenge to support user 326 (e.g., qr_challenge via email);
App connects securely to the customer support portal using support user credentials from vendor identity provider 328;
Use app_id to retrieve the corresponding vsk for the site/application_id 330;
Retrieve email_id of the support user, determine a shared secret as shared_v=challenge\hat{ }vsk, use a key derivation function to generate (hmac_key, totp_key)=PBKDF2(HMAC, shared_v, sess_id, iterations, key-length), generate a password=HMAC(hmac_key, sess_id+email_id) 332;
Return (password, totp_key, sess_id) to support user 334 (e.g., via phone app);
Generate current TOTP token (totp_cur) 336;
Initiate login to the application using sess_id:email_id for username and password:totp_cur for credentials 338;
Extract sess_id and email_id from username, extract password and totp_cur from credentials, use sess_id to retrieve the corresponding (hmac_key, totp_key), determine the password to verify password_v=HMAC(hmac_key, sess_id+email_id), determine the TOTP token to verify totp_cur_v, verify that password_v matches provided password and totp_cur_v matches totp_cur 340;
On successful verification create a support user session (otherwise error out) 342; and
Troubleshoot system using the new session 344.

### Example Procss Flows

FIG. 4 illustrates an example process flow that can facilitate secure access to applications by support user accounts, in accordance with an embodiment of this disclosure. In some examples, one or more embodiments of process flow 400 can be implemented by system architecture 100 of FIG. 1, or computing environment 1100 of FIG. 11.

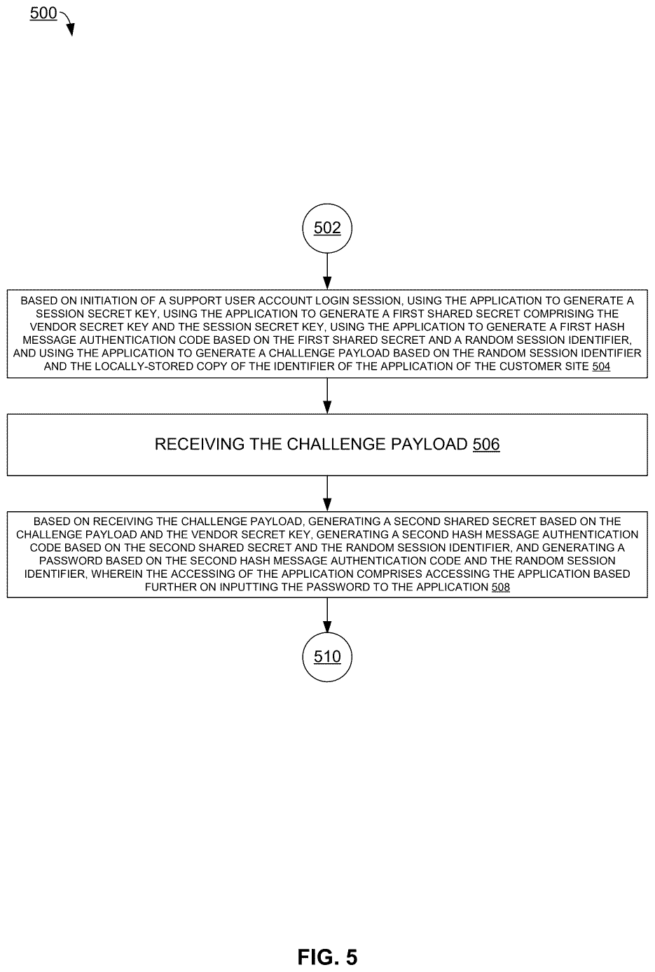

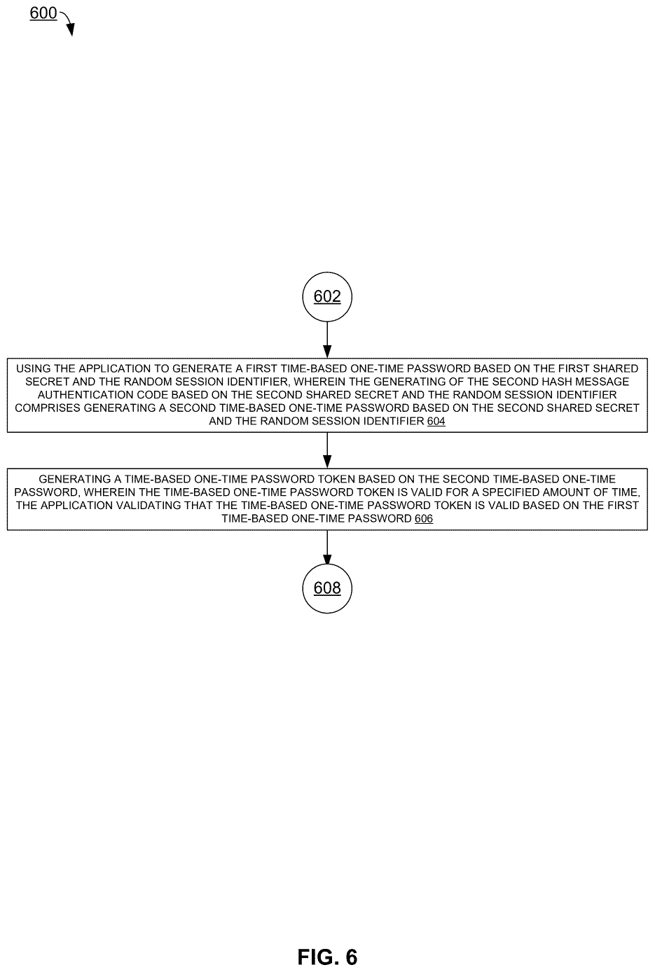

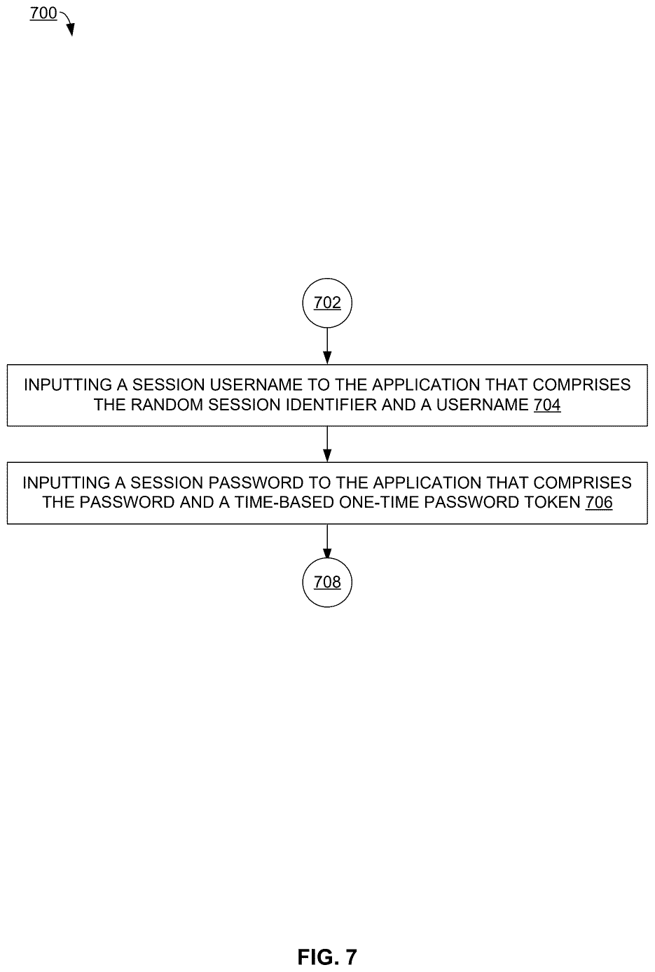

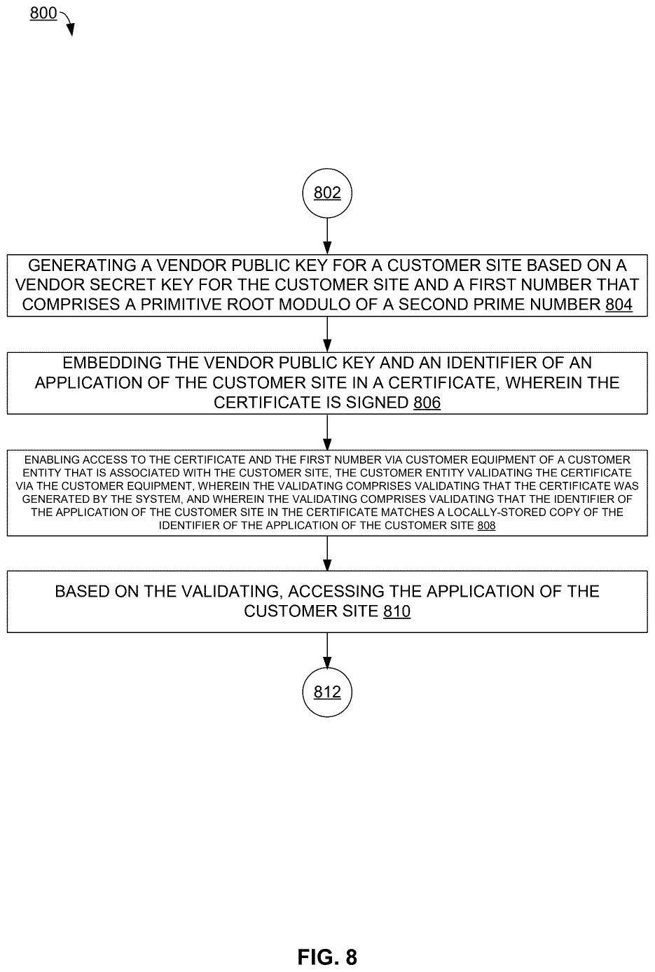

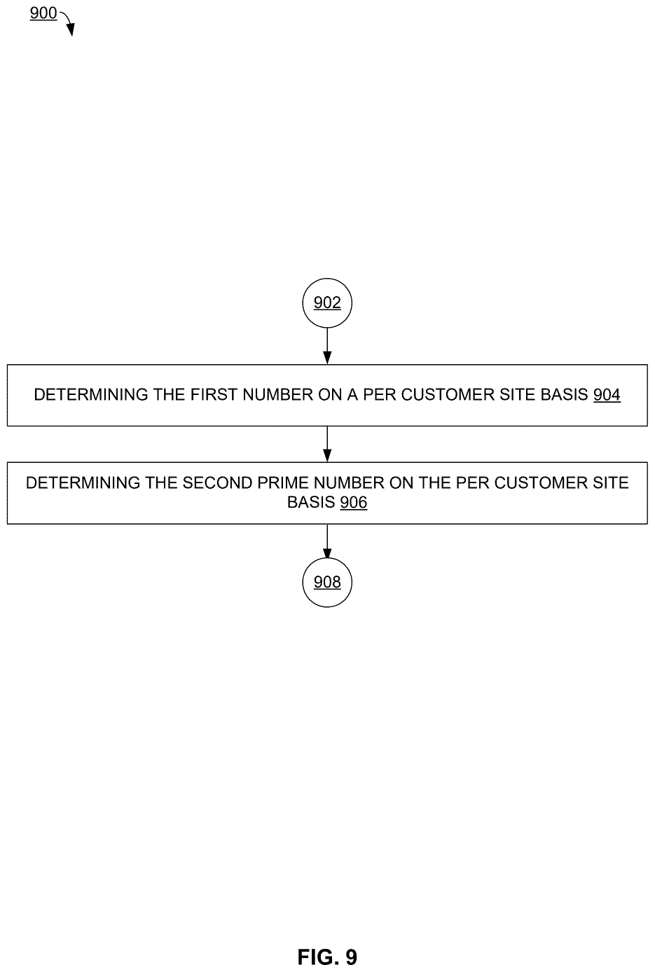

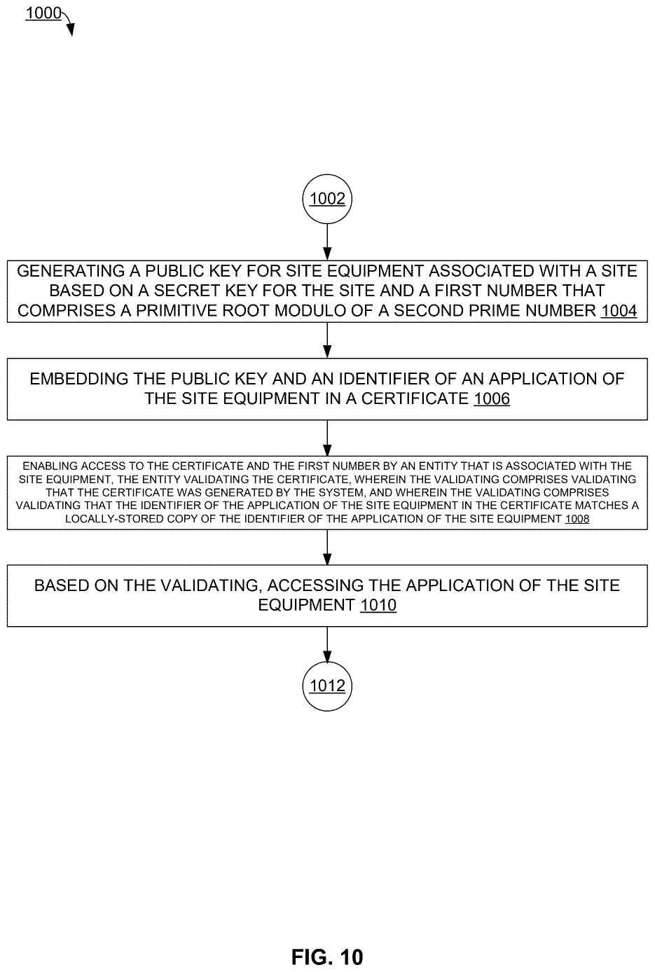

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of process flow process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts generating a vendor secret key for a customer site. This can comprise a vendor generating a vendor secret key (vsk) for a site

After operation 404, process flow 400 moves to operation 406.

Operation 406 depicts generating a vendor public key for the customer site based on the vendor secret key and a first number that comprises a primitive root modulo of a second prime number. This can comprise the vendor using vsk to compute the corresponding vendor public key (vpk=g\hat{ }vsk).

After operation 406, process flow 400 moves to operation 408.

Operation 408 depicts embedding the vendor public key and an identifier of an application of the customer site in a certificate, wherein the certificate is signed. This can comprise embedding the vpk is in a certificate (vcert) signed by the vendor. The site/application id (app_id) can also be embedded into the certificate.

After operation 408, process flow 400 moves to operation 410.

Operation 410 depicts enabling access to the certificate and the first number via a customer device corresponding to a customer entity that is associated with the customer site, the customer entity validating the certificate via the customer device, wherein the validating comprises validating that the certificate was generated by the system, and wherein the validating comprises validating that the identifier of the application of the customer site in the certificate matches a locally-stored copy of the identifier of the application of the customer site. This can comprise the vendor distributing the certificate vcert along with the along with the cryptographic parameter g to the customer, where the customer can log in to the application and uploads the certificate vcert and g. The application can verify the validity of the certificate by ensuring that it was generated by the vendor. It can then verify that the site/application id embedded in the certificate matches its own.

After operation 410, process flow 400 moves to operation 412.

Operation 412 depicts, based on the validating, accessing the application of the customer site. This can comprise facilitating a vendor support user to access the application at the customer site.

After operation 412, process flow 400 moves to 414, where process flow 400 ends.

FIG. 5 illustrates another example process flow that can facilitate secure access to applications by support user accounts, in accordance with an embodiment of this disclosure. In some examples, one or more embodiments of process flow 500 can be implemented by system architecture 100 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts, based on initiation of a support user account login session, using the application to generate a session secret key, using the application to generate a first shared secret comprising the vendor secret key and the session secret key, using the application to generate a first hash message authentication code based on the first shared secret and a random session identifier, and using the application to generate a challenge payload based on the random session identifier and the locally-stored copy of the identifier of the application of the customer site.

This can comprise, based on initiating a support user login session with the application over a secure channel, compute a shared secret as shared_c=vpk^{ssk}. A key derivation function can be used to generate a hmac_key and totp_key (hmac_key, totp_key)=PBKDF2(HMAC, shared_c, sess_id, iterations, key-length). A challenge payload (ch_payload) can be created and stored in the application, where the challenge payload can comprise session id—sess_id, site/application id—app_id.

In some examples, the generating of the first hash message authentication code is based on a first value that indicates a number of iterations of the generating to perform, and based on a second value that indicates a key length of the first hash message authentication code. This can be (hmac_key, totp_key)=PBKDF2(HMAC, shared_c, sess_id, iterations, key-length).

After operation 504, process flow 500 moves to operation 506.

Operation 506 depicts receiving the challenge payload. That is, the challenge payload can be delivered to a support user.

After operation 506, process flow 500 moves to operation 508.

Operation 508 depicts, based on receiving the challenge payload, generating a second shared secret based on the challenge payload and the vendor secret key, generating a second hash message authentication code based on the second shared secret and the random session identifier, and generating a password based on the second hash message authentication code and the random session identifier, wherein the accessing of the application comprises accessing the application based further on inputting the password to the application. That is, a determination of (hmac_key, totp_key)=PBKDF2(HMAC, shared_v, sess_id, iterations, key-length) can be made, as well as password=HMAC(hmac_key, sess_id+email_id). Then, a login to the application can be made using sess_id:email_id for username and password:totp_cur for credentials.

After operation 508, process flow 500 moves to 510, where process flow 500 ends.

FIG. 6 illustrates another example process flow that can facilitate secure access to applications by support user accounts, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts using the application to generate a first time-based one-time password based on the first shared secret and the random session identifier, wherein the generating of the second hash message authentication code based on the second shared secret and the random session identifier comprises generating a second time-based one-time password based on the second shared secret and the random session identifier.

In some examples, an output of a function produces the first hash message authentication code and the first time-based one-time password.

That is, a key derivation function can be used to generate a hmac_key and totp_key: (hmac_key, totp_key)=PBKDF2(HMAC, shared_c, sess_id, iterations, key-length), and (hmac_key, totp_key)=PBKDF2(HMAC, shared_v, sess_id, iterations, key-length) After operation 604, process flow 600 moves to operation 606.

Operation 606 depicts generating a time-based one-time password token based on the second time-based one-time password, wherein the time-based one-time password token is valid for a specified amount of time, the application validating that the time-based one-time password token is valid based on the first time-based one-time password. This can comprise the support user generating a current TOTP token (totp_cur), where the client site can compute the TOTP token to verify totp_cur_v.

After operation 606, process flow 600 moves to 608, where process flow 600 ends.

FIG. 7 illustrates another example process flow that can facilitate secure access to applications by support user accounts, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts inputting a session username to the application that comprises the random session identifier and a username. That is, sess_id:email_id can be used as the username.

After operation 704, process flow 700 moves to operation 706.

Operation 706 depicts inputting a session password to the application that comprises the password and a time-based one-time password token. That is, password: totp_cur can be used for a password.

In some examples, the password is a first password, the time-based one-time password token is a first time-based one-time password token, the application extracts the random session identifier and the username from the session username, the application extracts the first password and the time-based one-time password token from the session password, the application retrieves the first hash message authentication code and a time-based one-time password based on the random session identifier, the application determines a second password based on the first hash message authentication code and the session username, the application validates the first password based on the second password, and the application validates the first time-based one-time password token based on a second time-based one-time password token.

That is, the following can occur: extract the sess_id and email_id from username; extract the password and totp_cur from credentials; use the sess_id retrieve the corresponding (hmac_key, totp_key); compute the password to verify as password_v=HMAC(hmac_key, sess_id+email_id); compute the TOTP token to verify totp_cur_v; verify that password_v matches password provided and totp_cur_v matches totp_cur; and, if verification is successful create a support user session, and otherwise error out.

After operation 706, process flow 700 moves to 708, where process flow 700 ends.

FIG. 8 illustrates another example process flow that can facilitate secure access to applications by support user accounts, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow process flow 400 of FIG. 4, process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts generating a vendor public key for a customer site based on a vendor secret key for the customer site and a first number that comprises a primitive root modulo of a second prime number. In some examples, operation 804 can be implemented in a similar manner as operations 404-406 of FIG. 4.

In some examples, operation 804 comprises storing the vendor secret key, the vendor public key, the first number, the second prime number, the identifier of the application of the customer site, and the certificate in a key management system of the system. In some examples, the key management system is separate from any subsystem of the system that performs the generating of the vendor secret key, the generating of the vendor public key, the enabling, the validating, and the accessing. This can be an external KMS at the vendor site.

After operation 804, process flow 800 moves to operation 806.

Operation 806 depicts embedding the vendor public key and an identifier of an application of the customer site in a certificate, wherein the certificate is signed. In some examples, operation 806 can be implemented in a similar manner as operation 408 of FIG. 4.

After operation 806, process flow 800 moves to operation 808.

Operation 808 depicts enabling access to the certificate and the first number via customer equipment of a customer entity that is associated with the customer site, the customer entity validating the certificate via the customer equipment, wherein the validating comprises validating that the certificate was generated by the system, and wherein the validating comprises validating that the identifier of the application of the customer site in the certificate matches a locally-stored copy of the identifier of the application of the customer site. In some examples, operation 808 can be implemented in a similar manner as operation 410 of FIG. 4.

In some examples, operation 808 comprises rendering a user interface, wherein the enabling of the access to the certificate and the first number to the system is performed via the user interface. This can comprise the vendor setting up a customer support portal for specifying appropriate cryptographic parameters, generating and managing keys for all customer sites.

In some examples, operation 808 comprises creating an account for the customer site via the user interface. In some examples, operation 808 comprises based on determining, via the user interface, that an account for the customer site exists, refraining from creating the account for the customer site via the user interface. That, is a customer account can be created based on a login to the portal if one does not already exist.

After operation 808, process flow 800 moves to operation 810.

Operation 810 depicts, based on the validating, accessing the application of the customer site. In some examples, operation 810 can be implemented in a similar manner as operation 412 of FIG. 4.

After operation 810, process flow 800 moves to 812, where process flow 800 ends.

FIG. 9 illustrates another example process flow that can facilitate secure access to applications by support user accounts, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow process flow 400 of FIG. 4, process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts determining the first number on a per customer site basis.

After operation 904, process flow 900 moves to operation 906.

Operation 906 depicts determining the second prime number on the per customer site basis. That is, for operations 904-906, determining a prime p where g is a primitive root modulo p can be performed on a customer deployment/site basis.

After operation 906, process flow 900 moves to 908, where process flow 900 ends.

FIG. 10 illustrates another example process flow that can facilitate secure access to applications by support user accounts, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts generating a public key for site equipment associated with a site based on a secret key for the site and a first number that comprises a primitive root modulo of a second prime number. In some examples, operation 1004 can be implemented in a similar manner as operations 404-406 of FIG. 4.

In some examples, the generating of the public key comprises determining a result of performing exponential arithmetic on the first number by a value of the secret key. That is, a vendor can generate a vendor secret key (vsk) for a site and uses it to compute the corresponding vendor public key (vpk=g\hat{ }vsk).

After operation 1004, process flow 1000 moves to operation 1006.

Operation 1006 depicts embedding the public key and an identifier of an application of the site equipment in a certificate. In some examples, operation 1006 can be implemented in a similar manner as operation 408 of FIG. 4.

In some examples, the certificate is signed by a certificate authority that is associated with the system. That is, a vendor CA can sign the certificate.

After operation 1006, process flow 1000 moves to operation 1008.

Operation 1008 depicts enabling access to the certificate and the first number by an entity that is associated with the site equipment, the entity validating the certificate, wherein the validating comprises validating that the certificate was generated by the system, and wherein the validating comprises validating that the identifier of the application of the site equipment in the certificate matches a locally-stored copy of the identifier of the application of the site equipment. In some examples, operation 1008 can be implemented in a similar manner as operation 410 of FIG. 4.

In some examples, the enabling of the access to the certificate and the first number by the entity that is associated with the site equipment results in the certificate and the first number being stored in storage that is associated with the site equipment and that satisfies a secure storage criterion. That is, the application can verify the validity of the certificate by ensuring that it was generated by the vendor. It can then verify the site/application id embedded in the certificate matches its own. It can then store these two in its secure store.

In some examples, the enabling of the access to the certificate and the first number by the entity that is associated with the site equipment results in the certificate and the first number being uploaded to the application of the site equipment from a part of the site equipment that is different than the application. This can be similar to upload vendor-cert/g to application 232 of FIG. 2.

After operation 1008, process flow 1000 moves to operation 1010.

Operation 1010 depicts, based on the validating, accessing the application of the site equipment. In some examples, operation 1010 can be implemented in a similar manner as operation 412 of FIG. 4.

In some examples, the validating results in the application indicating to a part of the site equipment that is different than the application that the validating succeeded. This can be similar to return success 238 of FIG. 2.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of vendor site 102 and/or customer site 106 of FIG. 1.

In some examples, computing environment 1100 can implement one or more embodiments of the process flows of FIGS. 4-10 to facilitate secure access to applications by support user accounts.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types.

Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the. NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips. . .), optical discs (e.g., CD, DVD. . .), smart cards, and flash memory devices (e.g., card, stick, key drive. . .). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more”unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
generating a vendor secret key for a customer site;
generating a vendor public key for the customer site based on the vendor secret key and a first number that comprises a primitive root modulo of a second prime number;
embedding the vendor public key and an identifier of an application of the customer site in a certificate, wherein the certificate is signed;
enabling access to the certificate and the first number via a customer device corresponding to a customer entity that is associated with the customer site, the customer entity validating the certificate via the customer device, wherein the validating comprises validating that the certificate was generated by the system, and wherein the validating comprises validating that the identifier of the application of the customer site in the certificate matches a locally-stored copy of the identifier of the application of the customer site; and
based on the validating, accessing the application of the customer site.

2. The system of claim 1, wherein the operations further comprise:
based on initiation of a support user account login session,
using the application to generate a session secret key,
using the application to generate a first shared secret comprising the vendor secret key and the session secret key,
using the application to generate a first hash message authentication code based on the first shared secret and a random session identifier, and
using the application to generate a challenge payload based on the random session identifier and the locally-stored copy of the identifier of the application of the customer site;
receiving the challenge payload; and
based on receiving the challenge payload,
generating a second shared secret based on the challenge payload and the vendor secret key,
generating a second hash message authentication code based on the second shared secret and the random session identifier, and
generating a password based on the second hash message authentication code and the random session identifier,
wherein the accessing of the application comprises accessing the application based further on inputting the password to the application.

3. The system of claim 2, wherein the using of the application to generate the first hash message authentication code comprises the using of the application to generate a first time-based one-time password based on the first shared secret and the random session identifier,
wherein the generating of the second hash message authentication code based on the second shared secret and the random session identifier comprises generating a second time-based one-time password based on the second shared secret and the random session identifier,
wherein the operations further comprise:
generating a time-based one-time password token based on the second time-based one-time password, and
wherein the time-based one-time password token is valid for a specified amount of time, the application validating that the time-based one-time password token is valid based on the first time-based one-time password.

4. The system of claim 3, wherein an output of a function produces the first hash message authentication code and the first time-based one-time password.

5. The system of claim 2, wherein the generating of the first hash message authentication code is based on a first value that indicates a number of iterations of the generating to perform, and based on a second value that indicates a key length of the first hash message authentication code.

6. The system of claim 2, wherein the accessing of the application based on the inputting of the password to the application comprises:
inputting a session username to the application that comprises the random session identifier and a username; and
inputting a session password to the application that comprises the password and a time-based one-time password token.

7. The system of claim 6, wherein the password is a first password,
wherein the time-based one-time password token is a first time-based one-time password token,
wherein the application extracts the random session identifier and the username from the session username,
wherein the application extracts the first password and the time-based one-time password token from the session password,
wherein the application retrieves the first hash message authentication code and a time-based one-time password based on the random session identifier,
wherein the application determines a second password based on the first hash message authentication code and the session username,
wherein the application validates the first password based on the second password, and
wherein the application validates the first time-based one-time password token based on a second time-based one-time password token.

8. A method, comprising:
generating, by a system comprising at least one processor, a vendor public key for a customer site based on a vendor secret key for the customer site and a first number that comprises a primitive root modulo of a second prime number;
embedding, by the system, the vendor public key and an identifier of an application of the customer site in a certificate, wherein the certificate is signed;
enabling, by the system, access to the certificate and the first number via customer equipment of a customer entity that is associated with the customer site, the customer entity validating the certificate via the customer equipment, wherein the validating comprises validating that the certificate was generated by the system, and wherein the validating comprises validating that the identifier of the application of the customer site in the certificate matches a locally-stored copy of the identifier of the application of the customer site; and
based on the validating, accessing, by the system, the application of the customer site.

9. The method of claim 8, further comprising:
rendering, by the system, a user interface, wherein the enabling of the access to the certificate and the first number to the system is performed via the user interface.

10. The method of claim 9, further comprising:
creating, by the system, an account for the customer site via the user interface.

11. The method of claim 9, further comprising:
based on determining, via the user interface, that an account for the customer site exists, refraining, by the system, from creating the account for the customer site via the user interface.

12. The method of claim 8, further comprising:
storing, by the system, the vendor secret key, the vendor public key, the first number, the second prime number, the identifier of the application of the customer site, and the certificate in a key management system of the system.

13. The method of claim 12, wherein the key management system is separate from any subsystem of the system that performs the generating of the vendor secret key, the generating of the vendor public key, the enabling, the validating, and the accessing.

14. The method of claim 8, further comprising:
determining, by the system, the first number on a per customer site basis; and
determining, by the system, the second prime number on the per customer site basis.

15. A non-transitory computer-readable medium comprising instructions that, in response to execution, cause a system comprising at least one processor to perform operations, comprising:
generating a public key for site equipment associated with a site based on a secret key for the site and a first number that comprises a primitive root modulo of a second prime number;
embedding the public key and an identifier of an application of the site equipment in a certificate;
enabling access to the certificate and the first number by an entity that is associated with the site equipment, the entity validating the certificate, wherein the validating comprises validating that the certificate was generated by the system, and wherein the validating comprises validating that the identifier of the application of the site equipment in the certificate matches a locally-stored copy of the identifier of the application of the site equipment; and
based on the validating, accessing the application of the site equipment.

16. The non-transitory computer-readable medium of claim 15, wherein the generating of the public key comprises determining a result of performing exponential arithmetic on the first number by a value of the secret key.

17. The non-transitory computer-readable medium of claim 15, wherein the enabling of the access to the certificate and the first number by the entity that is associated with the site equipment results in the certificate and the first number being stored in storage that is associated with the site equipment and that satisfies a secure storage criterion.

18. The non-transitory computer-readable medium of claim 15, wherein the certificate is signed by a certificate authority that is associated with the system.

19. The non-transitory computer-readable medium of claim 15, wherein the enabling of the access to the certificate and the first number by the entity that is associated with the site equipment results in the certificate and the first number being uploaded to the application of the site equipment from a part of the site equipment that is different than the application.

20. The non-transitory computer-readable medium of claim 15, wherein the validating results in the application indicating to a part of the site equipment that is different than the application that the validating succeeded.
